(19) United States
(12) Patent Application Publication
(10) Pub. No.: US 2026/0278543 A1
(43) Pub. Date: Sep. 17, 2026

(54) PERPETUAL INVENTORY ON THE BASIS OF A MODULAR STORAGE SPACE WITH COMPARTMENTS

(71) Applicant: Claude Bruno DRAGHI, NANTERRE (FR)

(72) Inventor: Claude Bruno DRAGHI, NANTERRE (FR)

(21) Appl. No.: 19/469,314

(22) PCT Filed: Mar. 20, 2024
(86) PCT No.: PCT/FR2024/050333

§ 371 Date: Sep. 25, 2025

(30) Foreign Application Priority Data
Mar. 31, 2023 (FR) 2303196

(51) Int. Cl. G06Q 10/087; G01G 19/414

(52) U.S. Cl. CPC G06Q 10/08772; G01G 19/4144

(57) ABSTRACT

A storage module for storing products (Px), includes a storage space for storing products (Px), including at least two weight sensors which are each capable of providing weight information, a computing unit configured to receive the weight information as input data, the storage module further includes a removable separator, a receiving element for the separator that is capable of receiving the separator and holding it between the two weight sensors, and a detection element for the separator, which is capable of providing information on the presence of the separator. The computing unit being configured to receive the information on the presence of the separator as input data, and to provide at least one piece of output data that represents the product inventory position as a function of the input data.

### TECHNICAL FIELD OF THE INVENTION

The present invention relates to the automation of a perpetual inventory of stocks by physical counting in a modular, compartmentalized, re-configurable storage space.

The invention relates in particular to a storage module for storing products and a method for determining a corresponding product inventory position.

### TECHNICAL BACKGROUND

Carrying out an annual stocktaking is a legal requirement for commercial companies. In the case of large, highly fluctuating stocks, this inventory can be particularly time-consuming and therefore costly in terms of manpower.

In the prior art, product storage spaces with weighing means are known. Such storage spaces automatically determine product stock levels by dividing the total weight of products measured by the unit weight of the products.

However, as these storage spaces are fixed, they are not suited to the varied and changing structures of the stocks. What's more, as each storage space has its own specific dimensions, it would be too costly to manufacture scales adapted to each space.

Document DE 20 2007 004399 U1 gives an example of a weighing surface system.

### SUMMARY OF THE INVENTION

The invention proposes a storage module for storing products, comprising:
a storage space for storing products, comprising at least two weight sensors which are each capable of providing weight information,
a computing unit configured to receive the weight information as input data,

the storage module being characterized in that it further comprises:
a removable separator,
a receiving element for the separator, which is capable of receiving the separator and holding it between the two weight sensors,
a detection element for the separator which is capable of providing information on the presence of the separator,

the computing unit being further configured to receive the information on the presence of the separator as input data and to provide at least one piece of output data that represents the product inventory position as a function of the input data.

According to other features of the invention:
the two weight sensors being placed in the same substantially horizontal plane P, the storage space comprises at least two product-receiving surfaces, each receiving surface being placed on either side of the receiving element and resting respectively on one of the two weight sensors;
the storage module comprises at least one transverse rail and the in that weight sensors are carried by the same transverse rail, the transverse rail providing the electrical connection between the sensors and the computing unit;
the storage module comprises at least two aligned transverse rails which are electrically connected to each other;
the storage module comprises at least two transverse rails placed parallel to each other in the plane P, namely:
a front rail comprising a first front sensor and a second front sensor, and
a rear rail comprising a first rear sensor and a second rear sensor,

and in that among the two product-receiving surfaces:
a first receiving surface rests on the first front sensor and the first rear sensor, and
a second receiving surface rests on the second front sensor and the second rear sensor,

the computing unit being configured to provide:
first weight information from the weight measurements of the first front sensor and the first rear sensor, and
second weight information from the weight measurements of the second front sensor and the second rear sensor;
the rail comprises recesses for receiving the weight sensors;
each receiving surface has on a lower face a protrusion shaped to cooperate with the recess intended to receive the weight sensor corresponding thereto in order to prevent any lateral movement of the receiving surface;
the storage module comprises a rear wall extending in the transverse and vertical directions, forming an abutment for the receiving surfaces and comprising the separator detection element;
the storage space comprises at least two bars fixed to a vertical wall, each bar being associated with a weight sensor and comprising:
a rod for receiving hanging products, the rod extending in a substantially longitudinal direction, and
a bearing plate forming a bend with the receiving rod, the bearing plate extending vertically downwards and bearing against the weight sensor associated with the bar, and
a joint around a transverse axis for securing the bar to the vertical wall at the bend.

The invention also relates to a method for determining an inventory position of products arranged in the storage space of an inventory device according to the invention, the method comprising a step of receiving weight information, wherein:
the computing unit receives information on the weight and presence of the separator, if the presence of the separator is not detected:
the computing unit supplies weight information corresponding to the combination of the weights measured by the sensors

if the presence of the separator is detected:
the computing unit provides first weight information for the first sensor(s) and second weight information for the second sensor(s).

According to other features of the invention:
the method comprises a preliminary step of setting parameters wherein: if the separator is not placed in the receiving element:
a product name and a product unit weight are stored so as to be associated with all sensors, and

if the separator is placed in the receiving element:
a first product name and a first unit weight are stored so as to be associated with the first weight sensor(s), and
a second product name and a second unit weight are stored so as to be associated with the second weight sensor(s);
the method is such that:
an identification tag is placed on each receiving surface or bar, and
the association between a product name or a unit weight and a sensor is achieved by means of the identification tag of the receiving surface or of the bar which is in contact with the sensor;
the method comprises an additional step for determining the total weight of each product, in which for each stored product name, a total product weight is associated as follows:

if the presence of the separator is not detected:
the weight information corresponding to the sum of the weights measured by the sensors is stored in the memory so as to be associated with the product name associated with the sensors,

if the presence of the separator is detected:
the first weight information is stored in the memory so as to be associated with the first product name and the second weight information is stored in the memory so as to be associated with the second product name;
the method comprises a further step of determining quantity of products wherein a quantity of products is associated with each product name, the quantity of products being obtained by dividing the total product weight by the product unit weight;
the method comprises a rearrangement step wherein:
if the separator was not placed in the receiving module, the separator is placed in the receiving module, or
if the separator was placed in the receiving module, the separator is removed from the receiving module, and
the step of setting parameters is repeated;
the method further comprises a step of misplaced item detection, wherein if the quantity of products is not an integer, then a misplaced item detection alert is raised;
the method comprises a step of receiving an order, wherein the quantity of products placed in the storage space is compared with an ordered quantity of products;
the method comprises detection of a product addition or removal, triggering the following steps:
receiving weight information,
determining the total weight of each product,
determining quantity of products;
the method comprises an additional step of triggering an alert when the quantity of products falls below a predetermined value;
the method comprises:
creating a database comprising at least one row per sensor and six columns:
filling out a first column, wherein the sensors are listed by means of identifiers specific to each sensor,
filling out a second column containing the weight information supplied by each sensor,
filling out a third column wherein an identifier for the receiving surface or bar associated with each sensor is entered,
sorting the database according to the identifier of the receiving surface or bar,
filling out a fourth column containing information on the presence of the separator upstream of the receiving surface or bar identified in the third column, the information on the presence of the separator being, for example, “0” when the separator is detected and “1” when the separator is not detected,
in a fifth column for product names, combining the rows from a row containing a “0” in the fourth column to a row preceding the next “0” in the fourth column,
in a sixth column, combining the weight information from the second column from a row containing a “0” in the fourth column to a row preceding the next “0” in the fourth column to obtain data corresponding to the inventory position of each product.

### BRIEF DESCRIPTION OF THE FIGURES

Further features and advantages of the invention will become apparent from the following detailed description, which may be understood with reference to the attached drawings in which:

FIG. 1 is a block diagram which schematically represents a storage module for storing products according to a first simple embodiment of the invention;

FIG. 2 is a schematic perspective view which shows a storage module for products according to a second, more complex, embodiment of the invention than the first;

FIG. 3 is a schematic top view showing a shelf of a storage module according to a third embodiment of the invention;

FIG. 4 is a top view enlargement of a rail on the shelf from FIG. 3;

FIG. 5 is a front view of a rail from FIG. 3 which shows the arrangement of the various elements shown;

FIG. 6 is a front view which shows the rear wall behind the shelf in FIG. 3;

FIG. 7 is a side view which shows a bar of a storage module such as the one shown in FIG. 2;

FIG. 8 is a schematic perspective view which shows a storage module for products according to an improved fourth embodiment of the invention;

FIG. 9 is a schematic top view which shows a shelf from the storage module in FIG. 8;

FIG. 10 is a top view enlargement of a rail on the shelf from FIG. 9;

FIG. 11 is a block diagram which schematically represents the various memories wherein the tables described in the fourth embodiment of the invention are stored.

### DETAILED DESCRIPTION OF THE INVENTION

For the description of the invention and comprehension of the claims, the vertical, longitudinal and transverse orientations according to the reference frame V, L, T indicated in the figures, whose longitudinal L and transverse T axes extend in a horizontal plane, will be adopted in a non-limiting manner and without reference to earth's gravity. By convention, the longitudinal axis L is oriented from the rear to the front.

In the following description, identical, similar or analogous elements will be referred to by the same reference numbers.

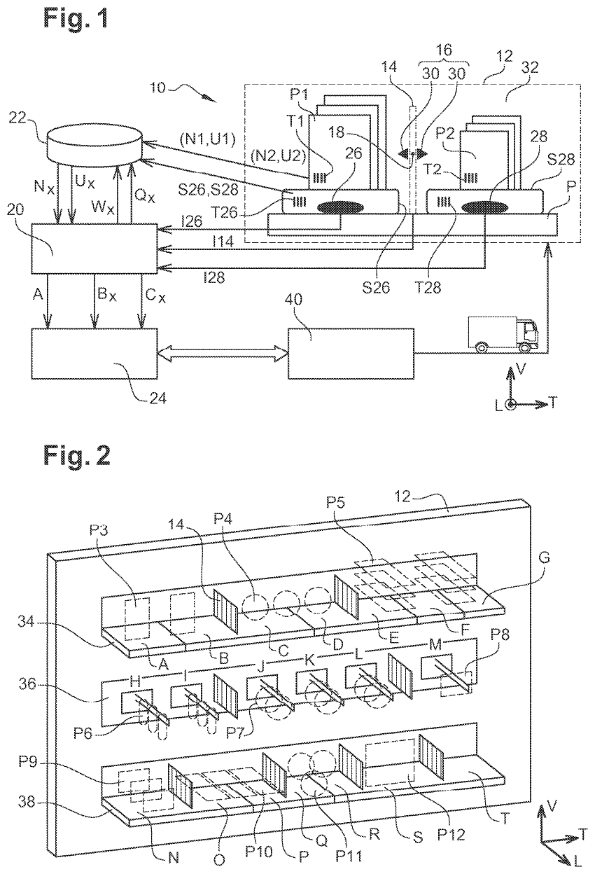

FIG. 1 shows the operation of a storage module 10 according to the invention. The storage module 10 comprises:
a storage space 12,
a removable separator 14,
a receiving element 16 for receiving the separator,
a detection element 18 for detecting the separator,
a computing unit 20,
a memory 22, and
a communication interface 24.

The storage space 12 comprises two weight sensors 26, 28, namely:
a first weight sensor 26 providing first weight information I26, and
a second weight sensor 28 providing second weight information I28.

The two weight sensors 26, 28 are aligned in the transverse direction T.

In the example, the two sensors 26 and 28 are positioned in the same, substantially horizontal, plane P. The storage space 12 further comprises two receiving surfaces S26 and S28 for receiving products P1 and P2, a first surface S26 resting on the weight sensor 26 and a second surface S28 resting on the weight sensor 28. Surfaces S26 and S28 are located on either side of the receiving module 16.

In FIG. 1, the separator 14 is positioned in the receiving element 16. In the example shown, the receiving element 16 comprises two studs 30 fixed to a flat rear wall 32 extending in the vertical V and transverse T directions. The two studs 30 are transversely aligned and spaced by the thickness of the separator 14 to within one mounting clearance to receive the separator 14 in the space between them. The transverse position of the receiving element 16 lies between the transverse position of the first weight sensor 26 and the transverse position of the second weight sensor 28. The separator 14 is shown in dotted lines in FIG. 1 to show that it can be removed from the receiving element 16.

The detection element 18 is positioned on the rear wall 32 between the studs 30. The detection element 18 for detecting the separator 14 is capable of providing information I14 on the presence of the separator 14. The detection element 18 is a switch, for example, which can be a push-button switch, an optical switch or a reed switch.

The computing unit 20 is configured to receive as input data:
the first weight information I26 from the first sensor 26,
the second weight information I28 from the second sensor 28, and
the information I14 on the presence of the separator 14.

In the example shown, a first batch of products P1 is arranged in the storage space 12 so as to weigh on the first sensor 26, and a second batch of products P2 is arranged in the storage space 12 so as to weigh on the second sensor 28. The first batch of products P1 is separated from the second batch of products P2 by the separator 14 placed in the receiving element 16.

In the context of the example shown in FIG. 1, a method in accordance with the invention will be described. The method is implemented by the computing unit 20. The method can make it possible to update a database wherein the total weights of products P1 and P2 are saved. The database is saved in the memory 22. An example of such a database is provided in Table 1 below.

TABLE 1

| | Sensor | | Presence of | Product | Total product |
|---|---|---|---|---|---|
| Sensor | information | Support | separator | name | weight |
| 26 | I26 | S26 | 1 | N1 | I26 |
| 28 | I28 | S28 | 0 | N2 | I28 |

Table 1 shows an example of the database associated with the example in FIG. 1, wherein the presence of the separator is detected.

Initially, for example when the storage space 12 is installed, the database is created in the form of a table. The table comprises a first row of column names, then two further rows (that is, one row per sensor), and six columns including:
a first column, “Sensor” to contain the list of sensors,
a second column, “Sensor information”, to contain weight information provided by each sensor,
a third column, “Support” to receive the identifier of the receiving support resting on the sensor identified in the first column,
a fourth column, “Presence of separator” containing information about the presence of the separator upstream of the receiving surface identified in the third column,
a fifth column, “Product name”, for the name of the product stored on the receiving surface identified in the third column, and
a sixth column, “Total product weight”, for the total weight of each product name.

The computing unit 20 then fills out the table as follows:
filling out the first column, wherein the sensors are listed by means of identifiers specific to each sensor 26, 28,
filling out the second column with the weight information I26, I28 provided by each sensor,
filling out the third column with an identifier of the receiving surface S26, S28 associated with each sensor,
filling out the fourth column with information on the presence of the separator upstream of the receiving surface, the information on the presence of the separator being, for example, “0” when the separator is detected and “1” when the separator is not detected. In Table 1, the “1” in the line for the first sensor 26 indicates that there is no separator upstream of the surface S26, and the “0” in the line for the second sensor 28 indicates that there is a separator upstream of the surface S28. The information on the presence of the separator in the line of the second sensor 28 corresponds to information I14.

This method then comprises the following steps:
setting parameters,
receiving weight information,
determining the total weight of each product,
determining quantities of products (this step will be described in the example in FIG. 2).

The method may further comprise the following steps:
Rearranging the racks,
Receiving orders and/or stocking shelves,
Detecting misplaced items,
Raising a threshold alert to warn of an inventory shortage.

The step of parameter-setting is a preliminary step wherein the information I14 on the presence of the separator 14 affects which action is performed in this step. This is because if the presence information I14 indicates that the separator 14 is not placed in the receiving module 16, then a product name and possibly a product unit weight are saved so as to be associated with all the sensors 26 and 28. Otherwise, that is if the presence information I14 indicates that the separator is placed in the receiving module, then a first product name and possibly a first unit weight are saved in the memory so as to be associated with the first weight sensor 26, and a second product name and possibly a second unit weight are saved in the memory so as to be associated with the second weight sensor 28.

To facilitate the step of parameter-setting, an identification tag T26, T28 is placed on each receiving surface S26, S28. Thus, a first tag T26 is placed on the first surface S26 and a second tag T28 is placed on the second surface S28. Likewise, the products also feature an identification tag T1, T2. The tags can be barcodes, QR codes, RFTD tags or any other means of identification.

The association between a product name or a unit weight and a sensor is achieved by means of the identification tag of the receiving surface S26, S28 which is in contact with the sensor. Thus, during the installation of the storage space 12, an operator uses a scanner in a “setting parameters” mode and scans the first tag T26 present on the first surface 26, then scans the tag T1 present on a first product PL. In a second step, the operator scans the second tag T28 present on the second surface 28, then scans the tag T2 present on a second product P2. This operation associates a product name N1, N2 with a sensor 26; 28 respectively. In one particular embodiment, the link between a product tag and the product itself can be made by means of an article code listed in an article table.

In the case shown in Table 1, the detection element 18 detects the presence of the separator 14 and therefore provides presence information I14 equal to “0”, indicating that the separator 14 is in place in the receiving module 16. Consequently, a first product P1 name N1 is associated with the first sensor 26 in the table, and a second product P2 name N2 is associated with the second sensor 28.

Another database example is provided in Table 2 below, corresponding to the removal of the separator 14.

TABLE 2

| | Sensor | | Presence of | Product | Total product |
|---|---|---|---|---|---|
| Sensor | information | Support | separator | name | weight |
| 26 | I26 | S26 | 1 | N1 | I26 + I28 |
| 28 | I28 | S28 | 1 | | |

Table 2 shows an example of the database associated with the example in FIG. 1, wherein the presence of the separator is not detected.

In the case shown in Table 2, the detection element 18 does not detect the presence of the separator 14 and therefore provides presence information I14 equal to “1”, indicating that the separator 14 is absent from the receiving module 16. Consequently, the first product P1 name N1 is associated with the first sensor 26 and the second sensor 28 in the table.

In the weight information reception step, the computing unit 20 receives weight information I26, I28 and information on the presence of the separator I14. The computing unit 20 then determines the total weight of each product depending on the presence of the separator 14.

If the presence of the separator is detected as shown in Table 1, the computing unit provides first weight information I26 for the first sensor 26 and second weight information I28 for the second sensor 28. Thus, in Table 1, the first weight information I26 is stored so as to be associated with the first product name N1 and the second weight information I28 is stored so as to be associated with the second product name N2.

If the presence of the separator 14 is not detected, as shown in Table 2, the computing unit provides weight information corresponding to a combination of the weights measured by sensors 26 and 28. In the example, the combination of weights corresponds to the sum of the weights. Thus, in Table 2, the weight information corresponding to the sum of the weights measured by the sensors 26 and 28 is stored in such a way as to be associated with the product name N1.

FIG. 2 shows a larger storage space 12 with 34 sensors than in FIG. 1. The storage space 12 comprises a top shelf 34, a row 36 of bars and a bottom shelf 38.

The top shelf 34 comprises seven receiving surfaces A-G for receiving products. The top shelf 34 is partitioned into three sections by two separators 14, one of which separator 14 divides surfaces B and C and the other divides surfaces D and E. A batch of products P3 is placed on the first section containing surfaces A and B, a batch of products P4 is placed on the second section containing surfaces C and D and a batch of products P5 is placed on the third section containing surfaces E, F and G.

The row 36 of bars comprises six receiving bars H-M for receiving products. The row 36 is divided into three sections by two separators 14, including one separator 14 between bars I and J and one separator 14 between bars L and M. A batch of products P6 hangs from bars H and I in the first section, a batch of products P7 hangs from bars J, K and L in the second section and a batch of products P8 hangs from bar M in the third section.

The bottom shelf 38 comprises seven receiving bars N-T for receiving products. The bottom shelf 38 is divided into five sections by four separators 14, including a separator 14 between surfaces N and O, a separator 14 between surfaces P and Q, a separator 14 between surfaces R and S and a separator 14 between surfaces S and T. A batch of products P9 is placed on the first section containing the surface N, a batch of products P10 is placed on the second section containing the surfaces O and P, a batch of products P11 is placed on a third section containing the Q and R surfaces, a batch of products P12 is placed on a fourth section containing the surface S and the fifth section corresponding to the surface T is left empty.

The surfaces A-G and N-T are each based on two sensors, one front sensor and one rear sensor. The bars H-M are each associated with a so-called weight sensor, as it is able to give the weight of the products hanging from the bar, as detailed in FIG. 7.

A database shown in Table 3 is created during the installation of the storage space 12 from FIG. 2.

TABLE 3

| | | | Weight | Presence | | Product | Total | Quantity |
|---|---|---|---|---|---|---|---|---|
| | Sensor | | on | of | Product | unit | product | of |
| Sensor | information | Support | support | separator | name | weight | weight | products |
| Sensor 1 | Isensor1 | A | IA = Isensor1 + | 0 | N3 | U3 | W3 = | Q3 = |
| | | | Isensor2 | | | | IA + IB | W3/U3 |
| Sensor 2 | Isensor2 | A | | | | | | |
| Sensor 3 | Isensor3 | B | IB = Isensor3 + | 1 | | | | |
| Sensor 4 | Isensor4 | B | Isensor4 | | | | | |
| Sensor 5 | Isensor5 | C | IC = Isensor5 + | 0 | N4 | U4 | W4 = | Q4 = |
| | | | Isensor6 | | | | IC + ID | W4/U4 |
| Sensor 6 | Isensor6 | C | | | | | | |
| Sensor 7 | Isensor7 | D | ID = Isensor7 + | 1 | | | | |
| Sensor 8 | Isensor8 | D | Isensor8 | | | | | |
| Sensor 9 | Isensor9 | E | IE = Isensor9 + | 0 | N5 | U5 | W5 = | Q5 = |
| | | | Isensor10 | | | | IE + IF + | W5/U5 |
| Sensor 10 | Isensor10 | E | | | | | IG | |
| Sensor 11 | Isensor11 | F | IF = Isensor11 + | 1 | | | | |
| | | | Isensor12 | | | | | |
| Sensor 12 | Isensor12 | F | | | | | | |
| Sensor 13 | Isensor13 | G | IG = Isensor13 + | 1 | | | | |
| | | | Isensor14 | | | | | |
| Sensor 14 | Isensor14 | G | | | | | | |
| Sensor 15 | Isensor15 | H | IH = Isensor15 | 0 | N6 | U6 | W6 = | Q6 = |
| | | | | | | | IH + 11 | W6/U6 |
| Sensor 16 | Isensor16 | I | II = Isensor16 | 1 | | | | |
| Sensor 17 | Isensor17 | J | IJ = Isensor17 | 0 | N7 | U7 | W7 = | Q7 = |
| | | | | | | | IK + IL | W7/U7 |
| Sensor 18 | Isensor18 | K | IK = Isensor18 | 1 | | | | |
| Sensor 19 | Isensor19 | L | IL = Isensor19 | 1 | | | | |
| Sensor 20 | Isensor20 | M | IM = Isensor20 | 0 | N8 | U8 | W8 = IM | Q8 = |
| | | | | | | | | W8/U8 |
| Sensor 21 | Isensor21 | N | IN = Isensor21 + | 0 | N9 | U9 | W9 = IN | Q9 = |
| | | | Isensor22 | | | | | W9/U9 |
| Sensor 22 | Isensor22 | N | | | | | | |
| Sensor 23 | Isensor23 | O | IO = Isensor23 + | 0 | N10 | U10 | W10 = | Q10 = |
| | | | Isensor24 | | | | IO + IP | W10/U10 |
| Sensor 24 | Isensor24 | O | | | | | | |
| Sensor 25 | Isensor25 | P | IP = Isensor25 + | 1 | | | | |
| | | | Isensor26 | | | | | |
| Sensor 26 | Isensor26 | P | | | | | | |
| Sensor 27 | Isensor27 | Q | IQ = Isensor27 + | 0 | N11 | U11 | W11 = | Q11 = |
| | | | Isensor28 | | | | IQ + IR | W11/U11 |
| Sensor 28 | Isensor28 | Q | | | | | | |
| Sensor 29 | Isensor29 | R | IR = Isensor29 + | 1 | | | | |
| | | | Isensor30 | | | | | |
| Sensor 30 | Isensor30 | R | | | | | | |
| Sensor 31 | Isensor31 | S | IS = Isensor31 + | 0 | N12 | U12 | W12 = IS | Q12 = |
| | | | Isensor32 | | | | | W12/U12 |
| Sensor 32 | Isensor32 | S | | | | | | |
| Sensor 33 | Isensor33 | T | IT = Isensor33 + | 0 | — | — | W13 = IT | — |
| | | | Isensor34 | | | | | |
| Sensor 34 | Isensor34 | T | | | | | | |

Table 3 shows an example of the database associated with the example in FIG. 2.

The following columns are similar to those described in FIG. 1:
“Sensor” column,
“Sensor information” column,
“Support” column,
“Presence of separator” column,
“Product name” column, and
“Total product weight” column.

The additional “Weight on support” column takes into account the fact that the surfaces A-G and N-T each rest on two sensors, and that the weight of the products resting on each surface therefore corresponds to the sum of the weight information provided by the front and rear sensors positioned under the surface in question.

In addition, in the example in Table 3, a product quantity determination is carried out. To do this, a unit weight Ux was previously entered for each product Px in the “Product unit weight” column during the step of parameter-setting. In the step of determining a quantity of products, a quantity of products Qx is associated with each product name Nx, the quantity of products Qx being obtained by dividing the total product weight Wx by the product unit weight Ux. The quantity of product Qx obtained is entered in the “Quantity of products” column.

In Table 3, the combination of sensors is clearly shown by the merging of the rows. Thus, from the fourth column “Weight on support” onwards, there is only one piece of global weight information for each support.

Similarly, from the sixth column onwards, there is only one row per product. Thus, based on the information on the presence of the separator, the rows are merged. More specifically, for the “Product name”, “Product unit weight”, “Total product weight” and “Quantity of products” columns, the rows are merged from a row containing a “0” in the “Presence of separator” column to the row preceding the next “0” in the “Presence of separator” column.

In addition, the method described in FIGS. 1 and 2 may comprise a step of rearranging. Rearranging involves enlarging or reducing the storage space for one or more products. This is the compartmentalized, modular aspect of the storage space of the invention. In this step, for at least one separator:
if the separator was not placed in the receiving module, the separator is placed in the receiving module, or
if the separator was placed in the receiving module, the separator is removed from the receiving module.

In this case, a new table is created and the step of setting parameters is repeated. This step typically takes place when there is a change in the organization of the storage space 12.

The method may further comprise a step of detecting misplaced items that is triggered when a product is placed back into a storage space outside the modes that allow product to be added. This is because apart from the modes that allow products to be added, that is, the rearrangement, installation and order receiving modes, the only “normal” actions consist in picking products from the storage spaces. If the computing unit 20 detects an addition of weight outside the modes that allow products to be added, this means that a product has been put back on a storage space, the risk being that the product put back is misplaced. The step of detecting misplaced items is based on the unit weight of the product as a warning. In the step of detecting misplaced items, the computing unit checks whether the quantity of products Qx is an integer. There are two possibilities:
the product put back has the same unit weight as the products stored in the space in question, then computing unit 20 determines that the quantity of products Qx is a whole number. In this case, it is a suspected misplaced item, and an operator must check the space, properly stow the misplaced item if necessary, and turn off the alarm.
if the product put back has a unit weight different from that of the products stored in the space in question, then the computing unit 20 detects that the quantity of products Qx is not an integer, and a misplaced item detection alert A is raised.

The alerts can be relayed on a screen and/or by sending an SMS by the computing unit 20 so that an operator can remove the misplaced item from the erroneous location, put it away where it should go if necessary, and end the alert.

According to one particular embodiment of the invention, the method may comprise an order reception step wherein the computing unit 20 compares each quantity of products Qx placed in the storage space 12 with an ordered quantity of products Cx received from the central order unit 40.

Advantageously, the method, in nominal mode, may comprise detecting a product addition or removal. The nominal mode may comprise the following steps:
receiving weight information,
determining the total weight of each product,
determining quantity of products.

The method can then include an additional step of triggering a product order Bx when the quantity of products is less than or equal to a predetermined value. An alert to trigger a product order Bx is sent by the computing unit 20 to the central control unit 40. The control unit 40 is typically integrated into the customer's information system. The computing unit 20 can send an alert via the communication interface 24 when the replenishment threshold is reached. The threshold is set by the customer according to their own criteria (order book, promotions, etc.)

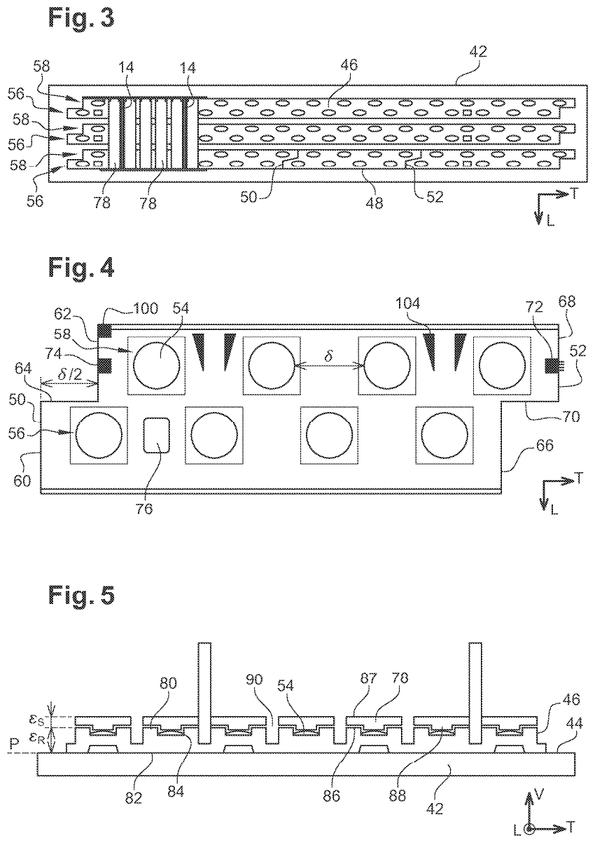

FIGS. 3 to 7 show particular embodiments of storage modules according to the invention.

FIGS. 3 to 6 show a storage module whose storage space 12 features a shelf 42 modeled on shelves 34 and 38 in FIG. 2.

As shown in FIG. 5, the shelf 42 comprises an upper surface 44 extending in a substantially horizontal plane P. The storage module 10 has three rows 46 of rails 48 fixed to the top surface 44. The rails 48 extend in a main direction of transverse elongation between a first end 50 on the left of the figures and a second end 52 on the right of the figures.

Each row 46 comprises multiple rails 48 aligned with each other so that the second end 52 of a first rail 48 is electrically and geometrically connected to the first end 50 of a second rail 48. In this way, the three rows 46 of rails run parallel to each other in transverse direction T.

FIG. 4 shows a 48 rail. The rail 48 has fourteen strain gauges 54 which can be likened to the weight sensors 26 and 28 in FIG. 1. The strain gauges 54 are staggered on the rail 48 in two parallel rows, a front row 56 and a rear row 58. The rail 48 has a Z-shape dictated by the locations of the strain gauges 54. This particular Z-shape, combined with male and female CAN (Controller Area Network) bus connectors, enables the rails to be fitted together to achieve any desired length. The fact that all the rails are identical means that a standard basic element can be used to simplify the creation of a new storage space and reduce costs through economies of scale.

Within a row 46 of a rail 48, the spacing o between the strain gauges 54 in the transverse direction T is constant. One row 46 of the rail 48 is divided between two consecutive strain gauges 54 of the same row and in particular halfway between the two consecutive strain gauges 54.

The first end 50 of the rail 48 comprises a first left edge 60 extending longitudinally and marking the start of the front row 56. The first strain gauge 54 in the front row 56 is located at a distance δ/2 from the first left edge 60. The first end 50 of the rail 48 has a second left edge 62 extending longitudinally and marking the start of the rear row 58. The first strain gauge 54 in the rear row 58 is located at a distance δ/2 from the second left edge 62. The second left edge 62 is connected to the first left edge 60 by a left connecting edge 64 extending in the transverse direction T. The left connecting edge 64 has a length equal to δ/2. The second left edge 62 is aligned longitudinally with the first front row gauge 56.

Symmetrically, the second end 52 of the rail 48 comprises a first right edge 66 extending longitudinally and marking the end of the front row 56. The last strain gauge 54 in the front row 56 is located at a distance δ/2 from the first right edge 66. The second end 52 of the rail 48 has a second right edge 68 extending longitudinally and marking the end of the rear row 58. The last strain gauge 54 in the rear row 58 is located at a distance δ/2 from the second right edge 68. The second right edge 68 is connected to the first right edge 66 by a right connecting edge 70 extending in the transverse direction T. The right connecting edge 70 has a length equal to δ/2. The first right edge 66 is aligned longitudinally with the last gauge of the rear row 58.

The recesses created by the connecting edges 64 and 70 give the rail 48 its Z-shape. This Z-shape allows the second end 52 of a first rail to be geometrically connected to the first end 50 of a second rail 48. Indeed, when two consecutive rails 48 are juxtaposed, the first right-hand edge 66 of the first rail 48 is adjacent to the first left-hand edge 60 of the second rail 48, and the same applies to the second edges 68 and 62 and the connecting edges 70 and 64.

In addition, each rail 48 has a male connector 72, positioned here on the second right edge 68. The male connector 72 is intended to be connected to a female connector 74 of a consecutive rail 48, the female connector 74 being positioned here on the second left edge 62. The connection between the male connector 72 of a rail 48 and the female connector 74 of the consecutive rail 48 makes the electrical connection between two consecutive rails. The rails 48 are then connected at the end of row 46 to the computing unit 20.

Each rail 48 comprises at least one microcontroller 76 capable of receiving measurements from the strain gauges 54 connected to it. The microcontroller 76 can also be queried by the computing unit 20 and transmit weight information based on measurements made by the strain gauges 54.

As shown in FIG. 3, the rows 46 of rail 48 are positioned parallel to each other so that there is a longitudinal alignment between:
a strain gauge 54 of the front row 56 of the front row,
a strain gauge 54 on the front row 56 of the middle row, and
a strain gauge 54 on the front row 56 of the rear row. This alignment also imposes a longitudinal alignment of the strain gauges 54 of the rear rows 58.

For each alignment of three sensors mentioned above, the storage space 12 comprises a product-receiving slat or surface 78 covering all three strain gauges 54 in the same alignment. The product-receiving surfaces 78 are similar to the surfaces S26, S28, as well as A-G and N-T described in FIGS. 1 and 2. Each slat or surface 78 completely covers all the strain gauges 54 of the alignment on which it rests. The weight supported by a slat or surface 78 corresponds to the combination of measurements provided by the three strain gauges 54 in the same alignment. For example, to obtain the weight supported by a slat or surface 78, the computing unit adds up the measurements provided by the three strain gauges 54 positioned under the slat or surface 78 in question.

The surfaces 78 are positioned parallel to one another and extend along a longitudinal elongation direction L. The surfaces 78 are spaced from one another to allow a separator 14 to be inserted between them. The spacing between two consecutive surfaces 78 is greater than or equal to the thickness of a separator 14.

FIG. 5 shows a front view of a row 46 of rails 48 from FIG. 3. The rails 48 have a thickness ε_{R} between an upper face 80 and a lower face 82 of the rails 48. Each rail 48 comprises recesses 84 each designed to receive a strain gauge 54. The recesses 84 have a complementary shape to that of the strain gauges 54. The recesses 84 are designed to provide lateral holding edges for the strain gauges 54.

Each receiving slat or surface 78 comprises on a lower face 86 a protrusion 88 shaped to cooperate with the recess 80 to prevent lateral movement of the receiving slat or surface 78. In the front view of FIG. 5, the receiving slat or surface 78 is T-shaped, at least locally.

The rail 48 comprises a longitudinal groove 90 forming a guide for the separator 14.

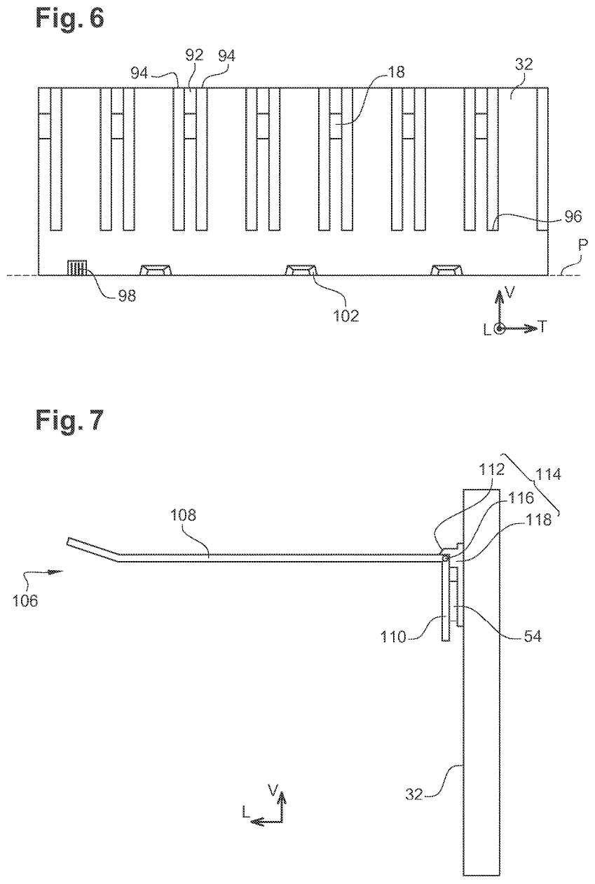

FIG. 6 shows a rear wall 32 similar to that shown in FIG. 1. The rear wall 32 comprises a succession of vertical slots 92 formed between two partitions 94 orthogonal to the rear wall 32. Each slot 92 is designed to receive a rear vertical edge of a separator 14. Each slot 92 comprises a detection element 18 to detect the presence of a separator 14 in the slot 92.

The partitions 94 comprise a lower edge 96 positioned at a distance from the plane P greater than the sum of the thickness ε_{R} of the rail 48 and the thickness εₛ of the slat or surface 78, to which a clearance is added. The thickness εₛ of the slat or surface 78 corresponds to the distance between the lower face 86 and an upper face 87 of the slat or surface 78.

The rear wall 32 and the lower edges 96 of the partitions 94 form a double stop for the receiving surfaces 78. Thus, the slats or surfaces 78 cannot move in the horizontal plane in the longitudinal direction towards the rear, nor in the vertical direction thanks to a stop placed on the rear wall 32. A set of front stops can complement the storage module to prevent surfaces 78 from moving vertically at their front end and longitudinally forwards.

The rear wall 32 is electrically connected to a rail 48 via a male connector 98 fixed to the rear wall 32 and cooperating with a female connector 100 fixed to the rail 48.

The rear wall 32 is geometrically connected to a rail 48 via a male clip 102 fixed to the rear wall 32 and cooperating with a female clip 104 fixed to the rail 48.

FIG. 7 shows a storage module whose storage space 12 comprises a row 36 of bars 106 similar to the row of bars H-M from FIG. 2. FIG. 7 shows a bar 106 attached to a rear wall 32.

The bar 106 comprises:
a rod 108,
a bearing plate 110,
a joint 114,
a support 118.

The rod 108 is used to receive hanging products. The rod 108 extends in a substantially longitudinal direction L.

The bearing plate 110 forms a bend 112 with the receiving rod 108. The bearing plate 110 extends vertically downwards and is applied against a strain gauge 54 associated with the bar 106.

The joint 114 makes a pivot connection about a transverse axis 116 between the bend 112 and the support 118.

The support 118 is applied against the rear wall 32 and secures the bar 106 to the rear wall 32.

When products are hanging from the rod 108, the assembly of the rod 108, bend 112 and plate 110 pivots slightly around the axis 116 so that the plate 110 exerts pressure on strain gauge 54 proportional to the weight of the hanging products. In this way, the strain gauge 54 provides a representative measure of the weight of the hanging products, and the strain gauge 54 behaves like a weight sensor.

An improved embodiment will now be presented.

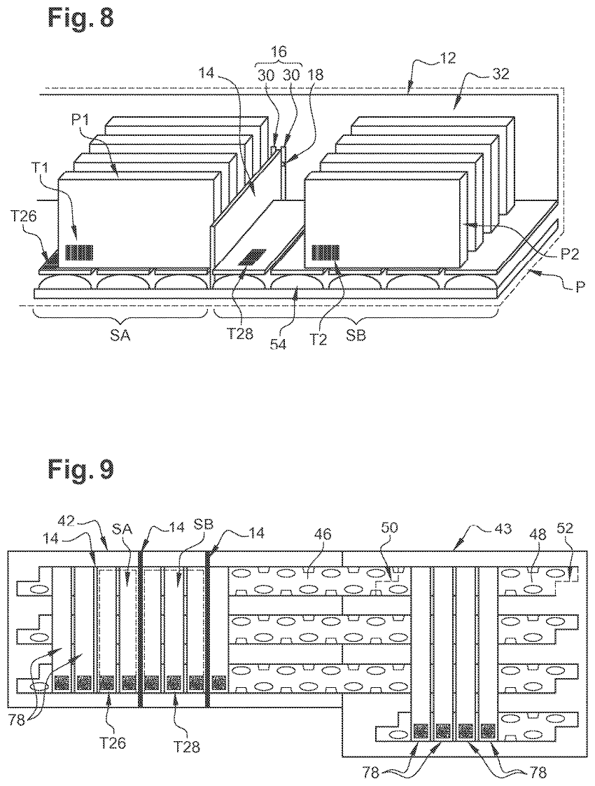

FIGS. 8 to 9 show a storage space 12 corresponding to a storage surface. This surface is compartmentalized using separators.

As shown in FIG. 9, the storage space 12 is made up of rails 48. As shown in FIG. 10, each rail 48 is fitted with fourteen strain gauges 54 spaced at regular intervals. These rails 48 and their strain gauges 54 form the base of a scale. Each rail 48 further comprises a male connector 72 on one side and a female connector 74 on the other. The connectors enable multiple rails to be connected together and thus placed end-to-end to obtain the desired length in the transverse direction T. The abutting interconnected rails 48 form a row of rails 46. To adapt to the storage surface along the longitudinal plane, one need only space the rows of rails 46 apart and/or add more, as shown on the right of the figure for the deep shelf 43, which comprises 4 rows of rails instead of the three rows of rails for the shelf 42 on the left of FIG. 9. Finally, to create the storage surface, slats or surfaces 78 are laid perpendicular to the rails on the strain gauges 54. Their length can be adapted along the longitudinal axis L as required. They are juxtaposed in the transverse direction as far as necessary to cover the storage surface. The slats or surfaces 78 are parallel to each other and extend along the longitudinal direction L. They form the pans of the scales. It is the arrangement of these different elements (rails, slats) that enables the invention to adapt to any storage surface. In order to be identified, each slat has a unique tag T26. In this way, each slat or surface 78 rests on at least 2 strain gauges, each on a different row of rails 46.

Each rail 48 is equipped with two CAN 2.0A microcontrollers. The rails 48 are connected to each other via a CAN 2.0A bus, well known in the automotive industry. Each microcontroller has a unique identifier, and each is able to identify each of the strain gauges 54 connected to it. In this way, a unique number can be assigned to each strain gauge 54. By laying a slat to create both a storage surface and a scale pan, a matrix is created.

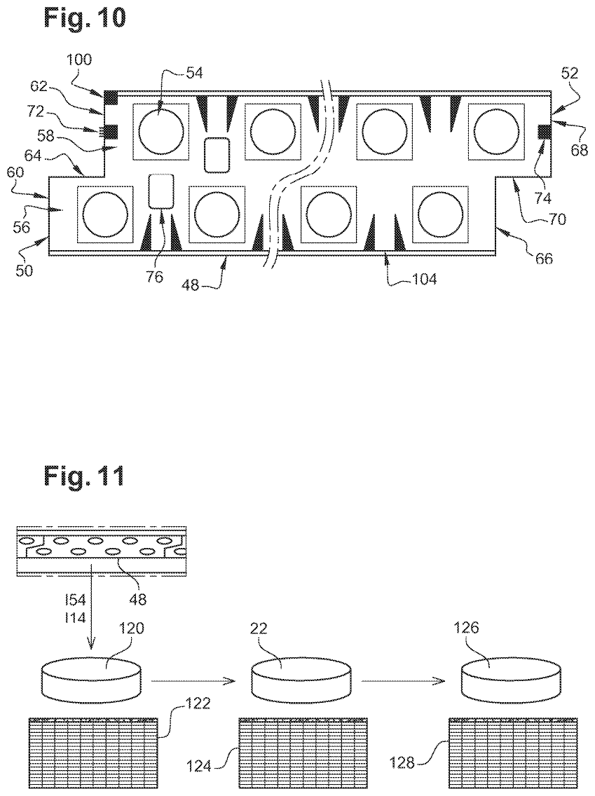

For its operation, the invention is based on three tables which are linked together as shown in FIG. 11. The three tables are:
a table of measurements 122,
a central table 124, and
a table of articles 128.

An example of a table of measurements 122 is shown in Table 4.

TABLE 4

| Id μC request | Id μC Data | Channel | Value | Active |
|---|---|---|---|---|
| 0x500 | 0x400 | 0 | 0 | 1 |
| 0x500 | 0x400 | 1 | 0 | 1 |
| 0x500 | 0x400 | 2 | 0 | 1 |
| 0x500 | 0x400 | 3 | 0 | 1 |
| 0x500 | 0x400 | 4 | 0 | 1 |
| 0x500 | 0x400 | 5 | 0 | 1 |
| 0x500 | 0x400 | 6 | 0 | 1 |
| 0x500 | 0x400 | 7 | 0 | 1 |
| 0x700 | 0x600 | 0 | 0 | 0 |
| 0x700 | 0x600 | 1 | 0 | 0 |
| 0x700 | 0x600 | 2 | 0 | 0 |
| 0x700 | 0x600 | 3 | 0 | 0 |
| 0x700 | 0x600 | 4 | 0 | 0 |
| 0x700 | 0x600 | 5 | 0 | 0 |
| 0x700 | 0x600 | 6 | 0 | 0 |
| 0x700 | 0x600 | 7 | 0 | 0 |
| 0x900 | 0x800 | 0 | 0 | 0 |
| 0x900 | 0x800 | 1 | 0 | 0 |
| 0x900 | 0x800 | 2 | 0 | 0 |
| 0x900 | 0x800 | 3 | 0 | 0 |
| 0x900 | 0x800 | 4 | 0 | 0 |
| 0x900 | 0x800 | 5 | 0 | 0 |
| 0x900 | 0x800 | 6 | 0 | 0 |
| 0x900 | 0x800 | 7 | 0 | 0 |

The table of measurements 122 populates the central table 124. The table of measurements 122 is stored in the measurement interface 120. The table of measurements 122 is stored in an Ethernet controller, for example. The measurement interface is equipped with a controller that itself has a memory, both for storing the computer code that manages it and the table of measurements 122. In addition to its MAC Address (Media Access Control: a physical address stored in a network card or interface), the measurement interface 120 sends the contents of table of measurements 122 via a WiFi network and Ethernet 2 frames to computing unit 20, which records the values received in central table 124. It contains the identifiers of each microcontroller connected to this measurement interface and the weight values measured by each gauge. Thanks to the combination of MAC Address, microcontroller identifier and gauge number, the system is able to store the right weight value in the right line of the central table 124.

The table of measurements 122 comprises five columns.

The first two columns “Id μC request” and “Id μC data” correspond to the identifiers of each microcontroller. There are two for each microcontroller. The first identifier is to be queried or programmed, the second identifier is to transmit its data. This is a particular feature of the CAN 2.0A technology used in the invention. These values are factory-set in each measurement interface and will be assigned, in sequence, to each microcontroller when they are connected to the communication interface.

A third column corresponds to the microcontroller channel. Each channel has eight. The first, channel 0, is dedicated to receiving position information I14 from the separators 14 associated with each strain gauge 54, which are connected to its 7 other channels. The value I14 corresponds to the sum of powers of 2 from 0 to 7. For example, if a separator 14 is positioned between strain gauges 3 and 4, its value is associated with strain gauge 54 #4 connected to channel #4. Its value will be 2⁴=16. Thanks to a simple algorithm, the computing unit 20 will know how to place the right value of the separator in the right line of the central table 124.

A fourth column, “value”, which receives information from the strain gauges I54, that is, the values measured by the strain gauges 54, or information on the presence of the separator I14.

A fifth column, “active”, tells the measurement interface controller whether or not the codes in the first two columns have already been assigned.

Table 5 shows an example of a central table 124.

TABLE 5

| | | | MAC | | | | Id μC | Id μC | Gauge | | Weight | Slat | Article |
|---|---|---|---|---|---|---|---|---|---|---|---|---|---|
| | Rack | Module | address | level | Row | Section | request | Data | number | Separator | (g) | number | code |
| SA | AC | 3 | 5E:FF:56: | 4 | 1 | 3 | 0x500 | 0x400 | 1 | 0 | 300 | ABC21 | DC2 |
| | | | A2:FF:15 | | | | | | | | | | |
| | AC | 3 | 5E:FF:56: | 4 | 2 | 3 | 0x900 | 0x800 | 1 | 1 | 250 | ABC21 | DC2 |
| | | | A2:FF:15 | | | | | | | | | | |
| | AC | 3 | 5E:FF:56: | 4 | 3 | 3 | 0xd00 | 0xc00 | 1 | 1 | 200 | ABC21 | DC2 |
| | | | A2:FF:15 | | | | | | | | | | |
| | AC | 3 | 5E:FF:56: | 4 | 1 | 3 | 0x700 | 0x600 | 2 | 1 | 250 | ABC22 | DC2 |
| | | | A2:FF:15 | | | | | | | | | | |
| | AC | 3 | 5E:FF:56: | 4 | 2 | 3 | 0xb00 | 0xa00 | 2 | 1 | 300 | ABC22 | DC2 |
| | | | A2:FF:15 | | | | | | | | | | |
| | AC | 3 | 5E:FF:56: | 4 | 3 | 3 | 0xf00 | 0xe00 | 2 | 1 | 200 | ABC22 | DC2 |
| | | | A2:FF:15 | | | | | | | | | | |
| SB | AC | 3 | 5E:FF:56: | 4 | 1 | 3 | 0x500 | 0x400 | 3 | 0 | 200 | ABC 23 | 12345 |
| | | | A2:FF:15 | | | | | | | | | | |
| | AC | 3 | 5E:FF:56: | 4 | 2 | 3 | 0x900 | 0x800 | 3 | 1 | 850 | ABC23 | 12345 |
| | | | A2:FF:15 | | | | | | | | | | |
| | AC | 3 | 5E:FF:56: | 4 | 3 | 3 | 0xd00 | 0xc00 | 3 | 1 | 700 | ABC23 | 12345 |
| | | | A2:FF:15 | | | | | | | | | | |
| | AC | 3 | 5E:FF:56: | 4 | 1 | 3 | 0x700 | 0x600 | 4 | 1 | 300 | ABC24 | 12345 |
| | | | A2:FF:15 | | | | | | | | | | |
| | AC | 3 | 5E:FF:56: | 4 | 2 | 3 | 0xb00 | 0xa00 | 4 | 1 | 480 | ABC24 | 12345 |
| | | | A2:FF:15 | | | | | | | | | | |
| | AC | 3 | 5E:FF:56: | 4 | 3 | 3 | 0xf00 | 0xe00 | 4 | 1 | 480 | ABC24 | 12345 |
| | | | A2:FF:15 | | | | | | | | | | |
| | AC | 3 | 5E:FF:56: | 4 | 1 | 3 | 0x500 | 0x400 | 5 | 1 | 200 | ABC25 | 12345 |
| | | | A2:FF:15 | | | | | | | | | | |
| | AC | 3 | 5E:FF:56: | 4 | 2 | 3 | 0x900 | 0x800 | 5 | 1 | 560 | ABC25 | 12345 |
| | | | A2:FF:15 | | | | | | | | | | |
| | AC | 3 | 5E:FF:56: | 4 | 3 | 3 | 0xd00 | 0xc00 | 5 | 1 | 730 | ABC25 | 12345 |
| | | | A2:FF:15 | | | | | | | | | | |

The central table is stored in memory 22. This clearly shows that the surface SA is associated with slats or surfaces 78 whose tags are ABC21 and ABC22. Similarly, the surface SB is associated with slats or surfaces 78 whose tags are ABC23, ABC24 and ABC25.

We can also see that the slat with tag ABC21 rests on strain gauge #1 of rail lines 1, 2 and 3. To return to FIG. 9, we can say that the slat T26 rests on the #1 strain gauges of the three rows of rails 46.

Each row of rails 46 is connected to a measurement interface 120, which transmits the information to the computing unit 20 for correct storage in the central table 124 of Table 5.

The switch 18 returns the value 0 and is associated with the strain gauge 54 of the first row of rails 46 corresponding to the rails 48 located at the bottom of the storage space along the longitudinal axis L.

To find out the total weight stored in a location delimited between two separators, the computing unit 20 adds up each weight returned by each gauge, from the first value I14 at 0 of the separator 14, to the next excluded value at 0.

Initially, for example when the storage space 12 is installed, the central table 124 is created in the form of a table such as those shown in Table 5. The table has a first row of column names, then as many rows as sensors. The number of lines is equal to the number of rails multiplied by the number of sensors per rail (in this case fourteen) and multiplied by the number of rows. The table has thirteen columns, including:
a first column, “Rack”, to contain the reference assigned to the storage space
a second column, “module”, to contain the reference information assigned to the measurement interface,
a third column, “MAC Address” for the unique identifier of the measurement interface,
a fourth column, “floor” to identify the level number of the storage surface in its rack
a fifth column, “line”, for the rail row number. They are numbered from 1 to n in the longitudinal direction. Row 1 corresponds to the lowest row in the storage space. It is this row #1 that receives the bottom stop and separator values.
a sixth column, “section”, corresponding to the rail number in its row.

The rails are installed from left to right.
the seventh and eighth columns “μC request” and “μC data” are the unique identifiers assigned to CAN 2.0A microcontrollers on transmit and receive.
a ninth column, “gauge”, to receive the number of the sensor 54 on the rail. They are numbered from 1 to 14 from left to right. Thanks to all the columns described above, each gauge can be clearly identified.
a tenth column, “separator”, containing information on the presence of the separator upstream of the gauge on the same row. Each separator is associated with the gauge immediately to its right. The separators are only on row #1.
an eleventh column, “weight”, the value of which is the strain gauge information I54, which is the measurement taken by the strain gauge 54 of this row by the microcontroller and transmitted to the communication interface 24 to be stored in memory.
a twelfth column, “slat number”, which will receive the identifier T26.x of each slat via its tag.
a thirteenth column, “Product code”, to receive the product code by means of its tag T1, T2.

An example of a table of articles 128 is shown in Table 6.

TABLE 6

| | Unit | Total | Initial | Final | Number | Article | Early | |
|---|---|---|---|---|---|---|---|---|
| Designation | weight | weight | number | number | received | code | alert | Alert |
| Pasta | 500 | 6000 | 6 | 12 | 6 | 12345 | 6 | 3 |
| Rice | 500 | 3000 | 2 | 6 | 4 | DC2 | 2 | 1 |
| Diapers | 2200 | 6600 | 3 | 3 | 0 | AZ12 | 2 | 1 |
| Sauce | 400 | 1600 | 2 | 4 | 2 | KB15 | 3 | 2 |

The table of articles 128 is shared with the customer and with the customer's information system 126 via the communication interface 24. It is linked to the central table 124 by the article code. This table is made up of as many rows as there are article or product cods, and nine columns.

The first column, “designation”, contains the product designation as given by the customer.

A second column, “unit weight”, corresponds to the weight of a single product. This value will be the divisor of the total weight to obtain the number of products stored.

A third column, “total weight”. This information is obtained by adding the weights of rows of the same product to the central table 124.

A fourth column, “initial number”. This is the number of products in stock before receiving goods.

A fifth column, “final number”. This is the number of products in stock at time t. It is always this number that is displayed and/or sent to the customer information system as the inventory position at time t.

A sixth column, “number received”. This number is obtained by performing the operation “final number” minus “initial number”. It is used in automatic reception mode to automatically know how much product has been added and thus received.

A seventh column, “article code” which, as its name suggests, is used to reference a product. It is this article code that links item table 128 to central table 124.

An eighth column, “pre-alert”, corresponding to the pre-alert threshold before going out of stock. This threshold is optional and is set by the customer.

A ninth column, “alert”, corresponding to the alert threshold for launching an order for this product. This threshold is also set by the customer.

The following describes how to set up and fill the racks for the first time. Prior to any installation of the invention, a plan of the storage spaces is drawn up in situ in order to allocate references to the racks, measure each dimension (L+T) for each rack and thus be able to predict the device that will be installed. This operation enables the system to determine the number of measuring interfaces required, the number of rail rows 46 per rack level, the number of rails 48 per level, and thus automatically create the database with the right number of rows, and fill in the values in the “rack-module-level-row-gauge number-separator” columns. Note that at this stage, all separator values are set to 1.

Once this table has been created and pre-set, the system determines the order in which the physical elements are to be installed by following its central table 124. Thus, we shall start with the first rack.

As seen previously, the “module” column designates the measurement interface reference. Once powered up, the measurement interface transmits its MAC address. This latter will be stored in the central table 124 in the first row in the “MAC Address” column, then replicated in each row as long as we are in the measurement interface 1, and so on for the next ones.

We then connect the first rail of the row 1. The CAN 2.0A microcontrollers then send a factory-set generic identifier, and the measurement interface assigns it the first free identifiers in its table of measurements 122.

Once each row of rails in the tack has been installed and tensioned, an operator can lay the slats and scan their tags T26 one by one from left to right. The system will then fill in the “slat” column with each tag value.

Now it is time to start arranging the products and installing the separators in the places chosen to delimit the storage spaces assigned to each product.

To store items, while the system is in installation mode, the product tag can be scanned, then the tag of one of the slats on the storage surface on which it is wished to be stored. So, from this T26 tag, the system searches for the first slat with a separator on its left, then on its right, and assigns the product code to all the lines in central table 124 between these two separators.

According to the invention, this principle of separators with recognition by the system makes it possible to make any storage space 12 compartmentalized into slats or surfaces 78.

Advantageously, when the article table 128 is incomplete or if the article does not exist, the invention enables it to be completed with “designation”, “article code” and “unit weight”.

In the step of receiving weight information, the computing unit 20 receives weight information from all the strain gauges 54 of a given measurement interface and information on the presence of the separator 14 from separator detection elements connected to that same interface. The computing unit 20 will then arrange this information in the central table 124 in the right places, thanks to the unique reference of each measurement interface, strain gauge and separator. For the record, this unique reference is made up of the MAC address of the worldwide unique measurement interface, the identifier of the CAN 2.0A microcontroller unique to each rail row, and the number of the 54 gauge connected to it.

The computing unit 20 then determines the total weight of each product depending on the presence of the separator 14.

Next, the computing unit 20 then performs the operation Total weight/unit weight to determine the number of products physically stored on each sub-surface SA and SB. The number of items is stored in the “final number” column.

Another example of a central table 124 is shown in Table 7.

TABLE 7

| | | | MAC | | | | Id μC | Id μC | Gauge | | Weight | Slat | Article |
|---|---|---|---|---|---|---|---|---|---|---|---|---|---|
| | Rack | Module | address | level | Row | Section | request | Data | number | Separator | (g) | number | code |
| A | AC | 3 | 5E:FF:56: | 4 | 1 | 3 | 0x500 | 0x400 | 1 | 0 | 300 | ABC21 | DC2 |
| | | | A2:FF:15 | | | | | | | | | | |
| | AC | 3 | 5E:FF:56: | 4 | 2 | 3 | 0x900 | 0x800 | 1 | 1 | 250 | ABC21 | DC2 |
| | | | A2:FF:15 | | | | | | | | | | |
| | AC | 3 | 5E:FF:56: | 4 | 3 | 3 | 0xd00 | 0xc00 | 1 | 1 | 200 | ABC21 | DC2 |
| | | | A2:FF:15 | | | | | | | | | | |
| B | AC | 3 | 5E:FF:56: | 4 | 1 | 3 | 0x700 | 0x600 | 2 | 1 | 250 | ABC22 | DC2 |
| | | | A2:FF:15 | | | | | | | | | | |
| | AC | 3 | 5E:FF:56: | 4 | 2 | 3 | 0xb00 | 0xa00 | 2 | 1 | 200 | ABC22 | DC2 |
| | | | A2:FF:15 | | | | | | | | | | |
| | AC | 3 | 5E:FF:56: | 4 | 3 | 3 | 0xf00 | 0xe00 | 2 | 1 | 300 | ABC22 | DC2 |
| | | | A2:FF:15 | | | | | | | | | | |
| C | AC | 3 | 5E:FF:56: | 4 | 1 | 3 | 0x500 | 0x400 | 3 | 0 | 200 | ABC23 | 12345 |
| | | | A2:FF:15 | | | | | | | | | | |
| | AC | 3 | 5E:FF:56: | 4 | 2 | 3 | 0x900 | 0x800 | 3 | 1 | 700 | ABC23 | 12345 |
| | | | A2:FF:15 | | | | | | | | | | |
| | AC | 3 | 5E:FF:56: | 4 | 3 | 3 | 0xd00 | 0xc00 | 3 | 1 | 850 | ABC23 | 12345 |
| | | | A2:FF:15 | | | | | | | | | | |
| D | AC | 3 | 5E:FF:56: | 4 | 1 | 3 | 0x700 | 0x600 | 4 | 1 | 300 | ABC24 | 12345 |
| | | | A2:FF:15 | | | | | | | | | | |
| | AC | 3 | 5E:FF:56: | 4 | 2 | 3 | 0xb00 | 0xa00 | 4 | 1 | 480 | ABC24 | 12345 |
| | | | A2FF:15 | | | | | | | | | | |
| | AC | 3 | 5E:FF:56: | 4 | 3 | 3 | 0xf00 | 0xe00 | 4 | 1 | 480 | ABC24 | 12345 |
| | | | A2:FF:15 | | | | | | | | | | |
| E | AC | 3 | 5E:FF:56: | 4 | 1 | 3 | 0x500 | 0x400 | 5 | 1 | 200 | ABC 25 | 12345 |
| | | | A2:FF:15 | | | | | | | | | | |
| | AC | 3 | 5E:FF:56: | 4 | 2 | 3 | 0x900 | 0x800 | 5 | 1 | 560 | ABC25 | 12345 |
| | | | A2:FF:15 | | | | | | | | | | |
| | AC | 3 | 5E:FF:56: | 4 | 3 | 3 | 0xd00 | 0xc00 | 5 | 1 | 730 | ABC25 | 12345 |
| | | | A2:FF:15 | | | | | | | | | | |
| F | AC | 3 | 5E:FF:56: | 4 | 1 | 3 | 0x700 | 0x600 | 6 | 0 | 200 | ABC26 | KB15 |
| | | | A2:FF:15 | | | | | | | | | | |
| | AC | 3 | 5E:FF:56: | 4 | 2 | 3 | 0xb00 | 0xa00 | 6 | 1 | 300 | ABC26 | KB15 |
| | | | A2:FF:15 | | | | | | | | | | |
| | AC | 3 | 5E:FF:56: | 4 | 3 | 3 | 0xf00 | 0xe00 | 6 | 1 | 300 | ABC26 | KB15 |
| | | | A2:FF:15 | | | | | | | | | | |
| G | AC | 3 | 5E:FF:56: | 4 | 1 | 3 | 0x500 | 0x400 | 7 | 1 | 150 | ABC27 | KB15 |
| | | | A2:FF:15 | | | | | | | | | | |
| | AC | 3 | 5E:FF:56: | 4 | 2 | 3 | 0x900 | 0x800 | 7 | 1 | 350 | ABC27 | KB15 |
| | | | A2:FF:15 | | | | | | | | | | |
| | AC | 3 | 5E:FF:56: | 4 | 3 | 3 | 0xd00 | 0xc00 | 7 | 1 | 300 | ABC27 | KB15 |
| | | | A2:FF:15 | | | | | | | | | | |

This central table 124 is associated with the storage module shown in FIG. 2. For the sake of simplicity, only surfaces A to G are listed.

In the central table 124 of Table 7, the computing unit 20 adds up the weight values of each strain gauge 54 from a first separator value I14 equal to 0 to the next excluded one. The computing unit 20 then positions itself on the article code of item table 128 corresponding to the sum it has just made, and then arranges this sum in item table 128 of Table 6 in the “total weight” column. The unit weight Ux has already been entered in item table 128 for each product Px in the “Product unit weight” column during the step of setting parameters. In the step of determining a quantity of products, a quantity of products Qx is associated with each product name Nx, the quantity of products Qx being obtained by dividing the total product weight Wx by the product unit weight Ux. The quantity of product Qx obtained is entered in the “Final number” column.

Table 8 shows another example of a central table 124 for bars.

TABLE 8

| | | | MAC | | | | Id μC | Id μC | Gauge | | Weight | Slat | Article |
|---|---|---|---|---|---|---|---|---|---|---|---|---|---|
| Rod | Rack | Module | address | level | Row | Section | request | Data | number | Separator | (g) | number | code |
| H | AC | 3 | 5E:FF:56: | 4 | 1 | 3 | 0x500 | 0x400 | 1 | 0 | 300 | DEF21 | PDT1A |
| | | | A2:FF:15 | | | | | | | | | | |
| I | AC | 3 | 5E:FF:56: | 4 | 1 | 3 | 0x900 | 0x800 | 1 | 0 | 270 | DEF22 | PDT1B |
| | | | A2:FF:15 | | | | | | | | | | |
| J | AC | 3 | 5E:FF:56: | 4 | 1 | 3 | 0xd00 | 0xc00 | 1 | 0 | 1000 | DEF23 | PDT2A |
| | | | A2:FF:15 | | | | | | | | | | |
| K | AC | 3 | 5E:FF:56: | 4 | 1 | 3 | 0x700 | 0x600 | 2 | 0 | 1250 | DEF24 | PDT2B |
| | | | A2:FF:15 | | | | | | | | | | |
| L | AC | 3 | 5E:FF:56: | 4 | 1 | 3 | 0xb00 | 0xa00 | 2 | 0 | 500 | DEF25 | PDT2C |
| | | | A2:FF:15 | | | | | | | | | | |
| M | AC | 3 | 5E:FF:56: | 4 | 1 | 3 | 0xf00 | 0xe00 | 2 | 0 | 1200 | DEF26 | PDT3 |
| | | | A2:FF:15 | | | | | | | | | | |

Table 9 shows an example of a table of articles 128 associated with the central table 124 in Table 8.

TABLE 9

| | Unit | Total | Initial | Final | Number | Article | Early | |
|---|---|---|---|---|---|---|---|---|
| Designation | weight | weight | number | number | received | code | alert | alert |
| AA batteries | 30 | 300 | 10 | 10 | 0 | PDT1A | 3 | 1 |
| AA batteries | 30 | 270 | 9 | 9 | 0 | PDT1B | 3 | 1 |
| Corkscrew | 250 | 1000 | 4 | 4 | 0 | PDT2A | 2 | 1 |
| Corkscrew | 250 | 1250 | 5 | 5 | 0 | PDT2B | 2 | 1 |
| Corkscrew | 250 | 500 | 2 | 12 | 0 | PDT2C | 2 | 1 |
| Oyster knife | 400 | 1200 | 3 | 3 | 0 | PDT 3 | 6 | 3 |

Tables 8 and 9 show an alternative way of managing bars in tables. In the central table 124 of Table 8, each separator value is always equal to 0, as if each bar had a separator. Using the same method as above, the computing unit doesn't need to add the total weight value, but instead places it in the article of tables 128 at the correct article code. If one wishes to store the same product Pn on several bars 106, when setting up or rearranging, the computing unit 20 will add a letter to its article code both in the central table 124 and in the item table 128. To find out the total quantity of the same article stored on several 106 bars, the computing unit 20 will add them together when transmitting to the customer information system. This association is made via the identical designation in table articles 128. Using the example in FIG. 2, we can see that the bars H, I have the same product “PDT1” and bars J, K, L the same product “PDT2”, while bar M is the only one to store the product “PDT3”. In addition, each bar 106 receives a unique tag. The tag value is stored in central table 124 in the “slat number” column.

So, for example, the product code “PDT1 A” and “PDT1 B” receive the same designation “AA batteries”, enabling the computing unit 20 to add up the “AA batteries” product quantities in item table 128 and send the sum to the customer information system.

The storage modules according to the invention enable inventory to be taken by physical counting, automatically and in real time.

The storage space is modular in that it may comprise:
a variable number of shelves or rows of bars,
it can be fitted with shelves or bars,
the shelves can be of variable lengths and widths thanks to the assembly of rails, which can be placed in series or in parallel.

The storage space can also be reconfigured thanks to the mobile nature of the separator.

Legend

| Px | product |
|---|---|
| Nx | names of product Px |
| Ux | unit weight of product X |
| Wx | total product weight X |
| Qx | quantity of products X |
| Tx | tag for product X |
| Bx | order for product X |
| Cx | quantity of product X ordered |
| 10 | storage module |
| 12 | storage space |
| 14 | separator |
| I14 | information on the presence of the separator |
| 16 | receiving element |
| 18 | detection element |
| 20 | computing unit |
| 22 | memory |
| 24 | communication interface |
| 26 | first weight sensor |
| I26 | first weight information |
| S26 | first surface |
| T26 | first tag |
| 28 | second weight sensor |
| I28 | second weight information |
| S28 | second surface |
| T28 | second tag |
| 30 | stud |
| 32 | rear panel |
| 34 | top shelf |
| 36 | row of bars |
| 38 | bottom shelf |
| A | misplaced item detection alert |
| 40 | central control unit |
| 42 | shelf |
| 43 | deep shelf |
| 44 | top surface |
| 46 | rail rows |
| 48 | rail |
| 50 | first end |
| 52 | second end |
| 54 | strain gauge |
| I54 | strain gauge information |
| 56 | front row |
| 58 | rear row |
| 60 | first left edge |
| 62 | second left edge |
| 64 | left connecting edge |
| 66 | first right edge |
| 68 | second right edge |
| 70 | right connecting edge |
| 72 | rail male connector |
| 74 | rail female connector |
| 76 | microcontroller |
| 78 | surface |
| 80 | topside of rail |
| 82 | underside of rail |
| 84 | recess |
| 86 | underside of surface |
| 87 | topside of surface |
| 88 | protrusion |
| 90 | groove |
| 92 | slot |
| 94 | partition |
| 96 | lower edge |
| 98 | rear wall male connector |
| 100 | rear wall female connector |
| 102 | male clip |
| 104 | female clip |
| 106 | bar |
| 108 | rod |
| 110 | plate |
| 112 | bend |
| 114 | joint |
| 116 | axis |
| 118 | support |
| 120 | measurement interface |
| 122 | table of measurements |
| 124 | central table |
| 126 | customer information system |
| 128 | table of articles |

1. A storage module for storing products (Px) comprising:
a storage space for storing products (Px), comprising at least two weight sensors which are each capable of providing weight information,
a computing unit configured to receive the weight information as input data,
the storage module being characterized in that it further comprises:
a removable separator,
a receiving element for the separator, which is capable of receiving the separator and holding it between the two weight sensors,
a detection element for the separator which is capable of providing information on a presence of the separator, and
the computing unit being further configured to receive the information on the presence of the separator as input data and to provide at least one piece of output data that represents a product inventory position as a function of the input data.

2. The storage module for storing products according to claim 1, wherein the two weight sensors being placed in the same substantially horizontal plane P, the storage space comprises at least two product-receiving surfaces, each receiving surface being placed on either side of the receiving element and resting respectively on one of the two weight sensors.

3. The storage module for storing products according to claim 2, wherein the storage module comprises at least one transverse rail and in that the weight sensors are carried by the same transverse rail, the transverse rail providing an electrical connection between the sensors and the computing unit.

4. The storage module for storing products according to claim 3, wherein the storage module comprises at least two aligned transverse rails electrically connected to one another.

5. The storage module for storing products according to claim 3, wherein the storage module comprises at least two transverse rails placed parallel to one another in plane P, namely:
a front rail comprising a first front sensor and a second front sensor, and
a rear rail comprising a first rear sensor and a second rear sensor, and in that among the two product-receiving surfaces:
a first receiving surface rests on the first front sensor and the first rear sensor, and
a second receiving surface rests on the second front sensor and the second rear sensor,
the computing unit being configured to provide:
first weight information from weight measurements of the first front sensor and the first rear sensor, and
second weight information from weight measurements of the second front sensor and the second rear sensor.

6. The storage module for storing products according to claim 3, wherein the rail has recesses for receiving the weight sensors.

7. The storage module for storing products according to claim 6, wherein each receiving surface has on a lower face a protrusion shaped to cooperate with the recess intended to receive its corresponding weight sensor in order to prevent lateral movement of the receiving surface.

8. The storage module for storing products according to claim 2, wherein the storage module comprises a rear wall extending in transverse and vertical directions forming an abutment for the receiving surfaces and comprising the detection element of the separator.

9. The storage module for storing products according to claim 1, wherein the storage space comprises at least two bars fixed to a vertical wall, each bar being associated with a weight sensor and comprising:
a rod for receiving hanging products, the rod extending in a substantially longitudinal direction, and
a bearing plate forming a bend with the receiving rod, the bearing plate extending vertically downwards and bearing against the weight sensor associated with the bar,
and
a joint around a transverse axis for securing the bar to the vertical wall at the bend.

10. A method for determining an inventory position of products arranged in the storage space of an inventory device according to claim 1, wherein the method comprises a step of receiving weight information wherein:
the computing unit receives weight and presence information from the separator,
if the presence of the separator is not detected:
the computing unit supplies weight information corresponding to the combination of the weights measured by the sensors if the presence of the separator is detected:
the computing unit provides first weight information for a first sensor(s) of the two weight sensors and second weight information for a second sensor(s) of the two weight sensors.

11. The method for determining a product inventory position according to claim 10, wherein the method comprises a preliminary step of parameter-setting, wherein:
if the separator is placed in the receiving element:
a product name (Px) and a product unit weight (Ux) are stored so as to be associated with all sensors, and
if the separator is placed in the receiving element:
a first product name (Px) and a first unit weight (Ux) are stored so as to be associated with the first weight sensor(s), and
a second product name (Px) and a second unit weight (Ux) are stored so as to be associated with the second weight sensor(s).

12. The method for determining a product inventory position according to claim 11, wherein:
an identification tag is placed on each receiving surface or bar, and
the association between a product name (Px) or unit weight (Ux) and a sensor is achieved by means of the identification tag of the receiving surface or bar which is in contact with the sensor.

13. The method for determining a product inventory position according to claim 11, wherein the method comprises a further step for determining a total weight of each product, wherein for each stored product name (Px) a total product weight (Wx) is assigned as follows:
if the presence of the separator is not detected:
the weight information corresponding to a sum of the weights measured by the sensors is stored in a memory so as to be associated with the product name (Px) associated with the sensors, if the presence of the separator is detected:
the first weight information is stored in the memory so as to be associated with the first product name and the second weight information is stored in the memory so as to be associated with the second product name.

14. The method for determining a product inventory position according to claim 13, wherein the method comprises a further quantity of products determination step wherein a quantity of products (Qx) is associated with each product name (Px), the quantity of products (Qx) being obtained by dividing the total product weight (Wx) by the unit product weight (Ux).

15. The method for determining a product inventory position according to claim 11, wherein the method comprises a rearrangement step wherein:
if the separator was not placed in the receiving module, the separator is placed in the receiving module, or
if the separator was placed in the receiving module, the separator is removed from the receiving module, and
the step of setting parameters is repeated.

16. The method for determining a product inventory position according to claim 15, wherein the method further comprises a step of detecting misplaced items wherein, if a quantity of products (Qx) is not an integer, then a misplaced item detection alert is raised.

17. The method for determining a product inventory position according to claim 14, wherein the method comprises a step of receiving an order, wherein the quantity of products (Qx) placed in the storage space is compared with an ordered quantity of products.

18. The method for determining a product inventory position according to claim 14, wherein the method comprises detection of a product addition or withdrawal triggering the following steps:
receiving weight information,
determining the total weight of each product, and
determining quantity of products.

19. The method for determining a product inventory position according to claim 14, wherein the method comprises an additional step of triggering an alert when the quantity of products is below a predetermined value.

20. The method for determining a product inventory position according to claim 13, wherein the method comprises:
creating a database comprising at least one row per sensor and six columns:
filling out a first column, wherein the sensors are listed by means of identifiers specific to each sensor,
filling out a second column containing the weight information supplied by each sensor,
filling out a third column wherein an identifier for the receiving surface or bar associated with each sensor is entered,
sorting the database according to the identifier of the receiving surface or bar,
filling out a fourth column containing information on the presence of the separator upstream of the receiving surface or bar identified in the third column, the information on the presence of the separator being, for example, “0” when the separator is detected and “1” when the separator is not detected,
in a fifth column for product names, combining the rows from a row containing a “0” in the fourth column to a row preceding a next “0” in the fourth column, and
in a sixth column, combining the weight information from the second column from a row containing a “0” in the fourth column to a row preceding the next “0” in the fourth column to obtain data corresponding to the inventory position of each product.
